(19) United States
(12) Patent Application Publication
(10) Pub. No.: US 2008/0174905 A1
(43) Pub. Date: Jul. 24, 2008

(54) Method and apparatus for recording data on a magnetic recording medium

(76) Inventor: Motohisa Ueda, Kanagawa-ken (JP)

Correspondence Address: DILLION & YUDELL LLP, 8911 N. CAPITAL OF TEXAS HWY, SUITE 2110, AUSTIN, TX, 78759, US

(21) Appl. No.: 11/823,506

(22) Filed: Jun. 28, 2007

(30) Foreign Application Priority Data
Jul. 19, 2006 (JP) JP2006-197426

(51) Int. Cl. G11B 5/596

(52) U.S. Cl. 360/77.04

(57) ABSTRACT

A method for recording data on a magnetic recording medium is disclosed. When data are written to a target track Tₙ, the numbers of effects on tracks Tₙ₋₁ and Tₙ₊₁ adjacent to a target track are counted as Adjacent Track Interference (ATI) effect counts Cₙ₋₁ and Cₙ₊₁, respectively, to determine whether or not the ATI effect counts Cₙ₋₁ and Cₙ₊₁ are greater than a permissible ATI count Np. If the ATI effect counts Cₙ₋₁ and Cₙ₊₁ are greater than the permissible ATI count Np, ATI error preventive processing is performed on the tracks Tₙ₋₁ and Tₙ₊₁. All sectors on the Tₙ₋₁ and Tₙ₊₁ are determined as to whether or not they are affected by ATI, and ATI error counter-measure processing is performed on all affected sectors to recover data.

### CROSS REFERENCE TO RELATED APPLICATIONS

The present application claims benefit of priority under 35 U.S.C. §§ 120, 365 to the previously filed Japanese Patent Application No. JP2006-197426 entitled, “Magnetic Recording System, Magnetic Recording Method, and Magnetic Recording Program” with a priority date of Jul. 19, 2006, which is incorporated by reference herein.

### BACKGROUND OF THE INVENTION

1. Technical Field

The present invention relates to magnetic recording systems in general, and more particularly, to a method and apparatus for recording data on a magnetic recording medium.

2. Description of Related Art

Hard disk drives are magnetic recording systems used for storage of information. Information is typically recorded on concentric tracks located on either side of one or more magnetic recording disks. The disk is rotatably supported by a spindle motor. Writing and reading of information to and from a track are performed by a recording/reproducing head provided at the tip of an actuator arm. The actuator arm is rotated by a voice coil motor. The voice coil motor is excited with current to rotate an actuator and move the recording/reproducing head. The recording/reproducing head senses a magnetic change generated from a disk surface to read information recorded on the disk surface. In order to record data on a track, current is supplied to the recording/reproducing head. The current supplied to the recording/reproducing head generates a magnetic field and the magnetic field magnetizes the disk surface.

In recent years, the distance between the recording/reproducing head and the disk has become shorter to narrow the track pitch in order to increase the density of recording. If the distance between the recording/reproducing head and the disk is shortened, when data are recorded on a track, tracks adjacent to the track may be overwritten due to leakage of a magnetic field generated by the recording/reproducing head, resulting in erasing the data recorded on the adjacent tracks.

Such a phenomenon is referred to as adjacent track erase resulting from Adjacent Track Interference (ATI). The adjacent track erase resulting from ATI can occur when repeated writing to an identical sector is continued without reading from/writing to other sectors in the vicinity. Specifically, for example, it can occur when some kinds of records (e.g., communication record, error history, etc.) are made in a certain location of a specific file or the specific file is used as a ring buffer.

In order to prevent the adjacent track erase resulting from ATI, one prior art method provides that the number of times of data recording in at least one sector of a first track of a hard disk drive is accumulated, and it is determined whether or not the accumulated number of times exceeds a predetermined number of times. If the accumulated number of times exceeds the predetermined number of times, data recorded on tracks adjacent to the track to which the sector concerned belongs is re-recorded. Since a track is adjacent to tracks on both sides thereof, it is affected by the tracks on both sides. However, if data on the track is re-recorded according to the number of times of data recording on an adjacent track on one side thereof, the effect of ATI cannot be accurately determined.

Consequently, it would be desirable to provide an improved method for recording data on a hard disk drive.

### SUMMARY OF THE INVENTION

In accordance with a preferred embodiment of the present invention, an adjacent track interference (ATI) compensation table is provided to store ATI effect count Cₙ along with an associated track Tₙ. After counting a number of ATI effects for a track Tₙ, the ATI effects count is recorded in the ATI compensation table. A determination is made whether or not there is any ATI affected sector within the ATI compensation table. If there is an ATI affected sector within the ATI compensation table, ATI error countermeasure processing is preformed to recover data and the ATI effect count Cₙ for the track Tₙ is reset.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a hard disk drive in which a preferred embodiment of the present invention is incorporated;

FIG. 2 is an example of an ATI compensation table;

FIG. 3 depicts the mechanism of ATI generation;

FIG. 4 depicts the effect of ATI on a read signal;

FIG. 5 depicts write process to the hard disk drive from FIG. 1;

FIG. 6 is a high-level logic flow diagram of a method for performing write process in the hard disk drive from FIG. 1;

FIG. 7 depicts read process from the hard disk drive from FIG. 1;

FIG. 8 is a high-level logic flow diagram of a method for performing read processing and ATI error preventive processing in the hard disk drive from FIG. 1;

FIG. 9 is a high-level logic flow diagram of a method for performing write processing according to an alternative embodiment of the present invention; and

FIG. 10 is a block diagram of a personal computer.

### DETAILED DESCRIPTION OF A PREFERRED EMBODIMENT

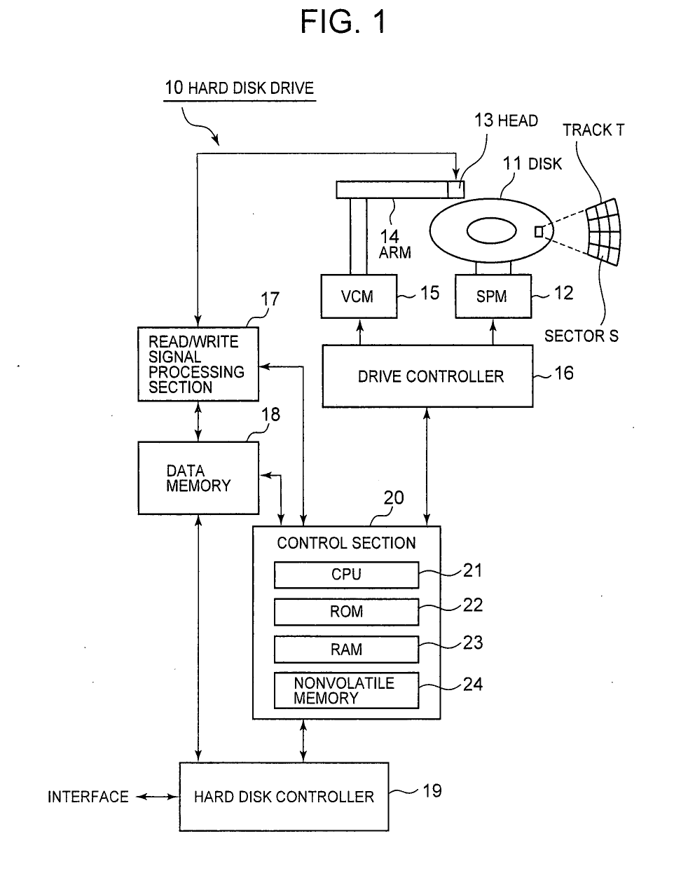

With reference now to the drawings, and in particular to FIG. 1, there is illustrated a block diagram of a hard disk drive in which a preferred embodiment of the present invention is incorporated. As shown, a hard disk drive 10 includes a disk 11, an spindle motor (SPM) 12, a head 13, an arm 14, a voice coil motor (VCM) 15, a drive controller 16, a read/write signal processing section 17, a data memory 18, a hard disk controller 19, and a control section 20.

Disk 11 is a disk as a magnetic recording medium on which various data inputted from the outside are recorded. On disk 11, multiple tracks T each having multiple sectors S are formed in a concentric manner. Each of the sectors has a size of 512 bytes, and position information of data recorded in units of sectors is managed for each sector. SPM 12 rotates disk 11. Head 13 performs signal reading/writing with respect to disk 11. Arm 14 supports head 13 in a fixed manner. VCM 15 feeds head 13 and arm 14 in the radial direction of disk 11. Drive controller 16 has drive circuits for driving SPM 12 and VCM 15, respectively, to control the driving of SPM 12 and VCM 15.

Read/write signal processing section 17 encodes data to be written to disk 11 and decodes data read from disk 11. During operation, read/write signal processing section 17 also performs encoding according to an error correction code and processing related to error detection and error correction. Data memory 18 performs buffering on data read from disk 11 and data to be written to disk 11. Hard disk controller 19 configures input/output circuits for exchanging data, control commands, etc, with a host apparatus such as a personal computer or audio/visual equipment through an interface. The interface can be Integrated Drive Electronics (IDE), Small Computer System Interface (SCSI), Fiber Channel (FC), or Universal Serial Bus (USB).

Control section 20 controls the entire operation of hard disk drive 10, and includes a CPU 21 for controlling the operation of hard disk drive 10 according to a firmware (magnetic recording program) stored in a ROM 22, ROM 22 storing the firmware executed by CPU 21, a RAM 23 used as work area for CPU 21, a nonvolatile memory 24 storing an ATI compensation table, etc.

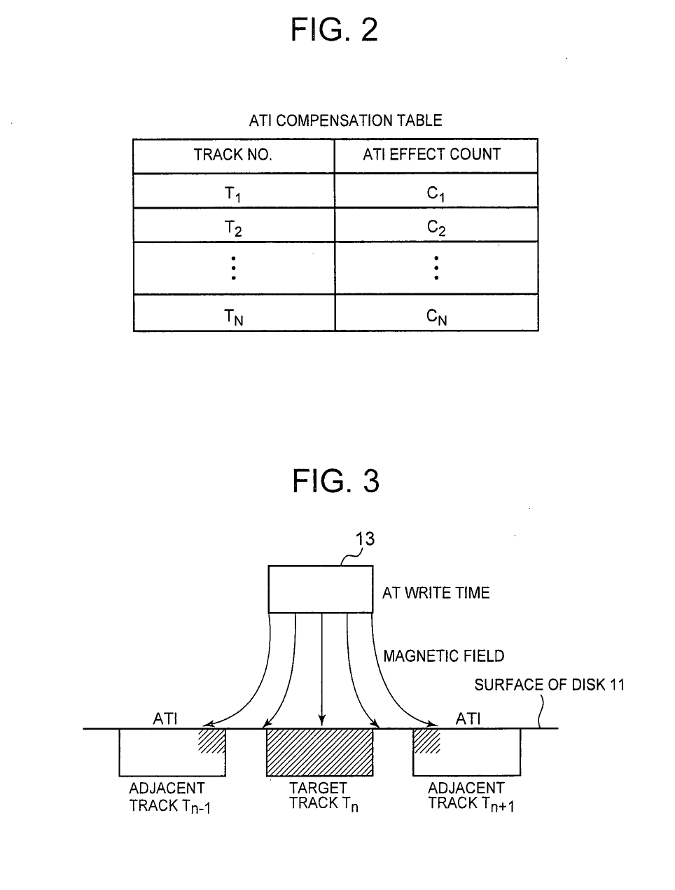

FIG. 2 is an example of the ATI compensation table. As shown, the number of ATI effects (the number of write effects) C₁ to C_{N} is recorded in the ATI compensation table for each track T₁ to T_{N} on disk 11. CPU 21 counts the number of ATI effects C₁ to C_{N} for each of the tracks T₁ to T_{N} on disk 11 and records the count in the ATI compensation table. Control section 20 functions as counting means, first determination means, second determination means, recovery means, and reset means to perform ATI error preventive processing and ATI error countermeasure processing to be described later.

The following describes the outline of operation of hard disk drive 10 configured as shown in FIG. 1. When receiving a command (write/read command, etc.) issued from the host apparatus through the interface, hard disk controller 19 interprets the content of the command and notifies it to control section 20. Control section 20 sets necessary commands and parameters based on the notified content, and instructs drive controller 16 and read/write signal processing section 17 to perform those operations.

Drive controller 16 controls the driving of SPM 12 and VCM 15 to move head 13 to a sector of a designated track on disk 11. Upon writing to disk 11, read/write signal processing section 17 encodes (modulates) data sent thereto into a digital bit stream. Upon reading, read/write signal processing section 17 removes high-level noise from a signal read from disk 11, performs conversion from the analog signal to a digital signal, and further performs error correction using an Error Correction Code (ECC). The ECC error correction is to make different levels of corrections depending on the degree of error in the read signal.

FIG. 3 depicts the mechanism of ATI generation. It is assumed that the write target track is an n^{th} track Tₙ (where n=1 to N). When head 13 generates a magnetic field on the n^{th} track Tₙ, the n^{th} track Tₙ is magnetized, so that the adjacent (n−1)^{th} track Tₙ₋₁ and (n+1)^{th} track Tₙ₊₁ are slightly affected by the leaked magnetic field. Suppose that data are recorded on the n^{th} track Tₙ continuously and repeatedly. As the number of records increases cumulatively, the probability for data respectively recorded on the (n−1)^{th} track Tₙ₋₁ and (n+1)^{th} track Tₙ₊₁ adjacent to the track Tₙ to be erased or damaged becomes higher, and hence a read error may occur.

The stages of errors caused by the effect of ATI will be described. (1) In early stages of the ATI effect, since degaussing effects are low, no error occurs or data can be read out by ECC error correction processing with a low ECC correction capability without any problem (no error or minor soft-error state). (2) In a middle stage of the ATI effect, although reading begins to be affected by degaussing, data can be read out by performing an Error Recovery Procedure (ERP) such as to increase the ECC correction capability, by moving the head position out of the center of the track, or by increasing the signal amplification factor (medium soft-error state). (3) In late stages of the ATI effect, since sufficient signal characteristics cannot be obtained due to degaussing effects, data cannot be read intermittently or data reading becomes impossible (severe soft-error state or hard error state (read error)).

The present invention allows for the prevention of the ATI effect in the medium soft-error stage (2) to prevent read errors (severe soft-error and hard error) caused by the ATI effect.

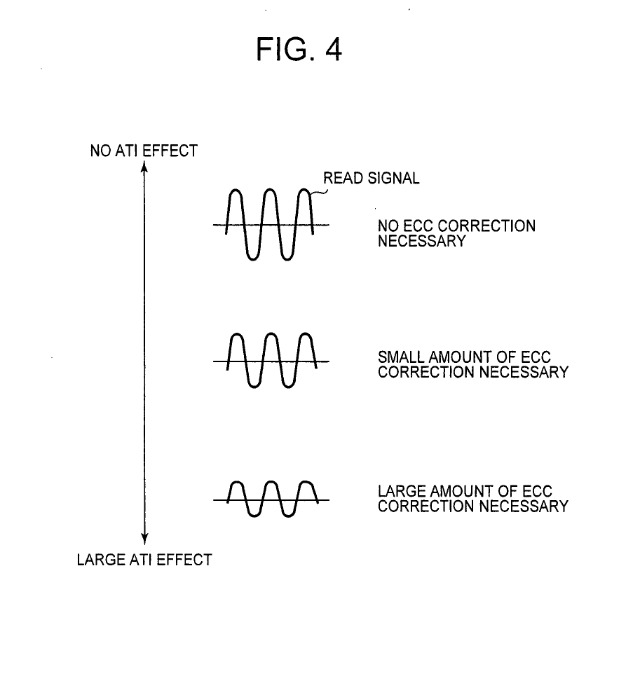

FIG. 4 depicts the effect of ATI on a read signal. As shown, the output level of the read signal is degraded as the ATI effect is increased. Therefore, the ECC correction capability needs to be strengthened. For example, the number of writes to the track Tₙ or Tₙ₋₂ adjacent to the (n−1)^{th} track Tₙ₋₁ and requiring an ECC correction capability P used in the medium soft-error stage (2) for sectors of the (n−1)^{th} track Tₙ₋₁ is set as the permissible number of ATI effects, or permissible ATI count, Np. This permissible ATI count Np is a value obtained for each hard disk drive as a result of design and process evaluation, because the write head width, writing characteristics, head fly-height, magnetic retention characteristics of medium magnetic layers vary from hard disk drive to hard disk drive. For example, the permissible ATI count Np can be set to several tens of thousands of times to several hundreds of thousands of times.

In the present embodiment, control section 20 counts the numbers of ATI effects on the (n−1)^{th} track Tₙ₋₁ and (n+1)^{th} track Tₙ₊₁ adjacent to the n^{th} track Tₙ as ATI effect counts Cₙ₋₁ and Cₙ₊₁, respectively, each time data are recorded on the n^{th} track Tₙ. As mentioned above, the ATI effect count C is recorded in the ATI compensation table. If the ATI effect count C exceeds the permissible ATI count Np, control section 20 performs ATI error preventive processing for reading data of all the sectors on the track T and determines the presence or absence of ATI effect on each sector to perform ATI error countermeasure processing (data rerecording, sector replacement, etc.) on the sector(s) determined to be affected by ATI, thereby preventing data reading errors (severe level of soft error and hard error) from occurring due to the effect of ATI.

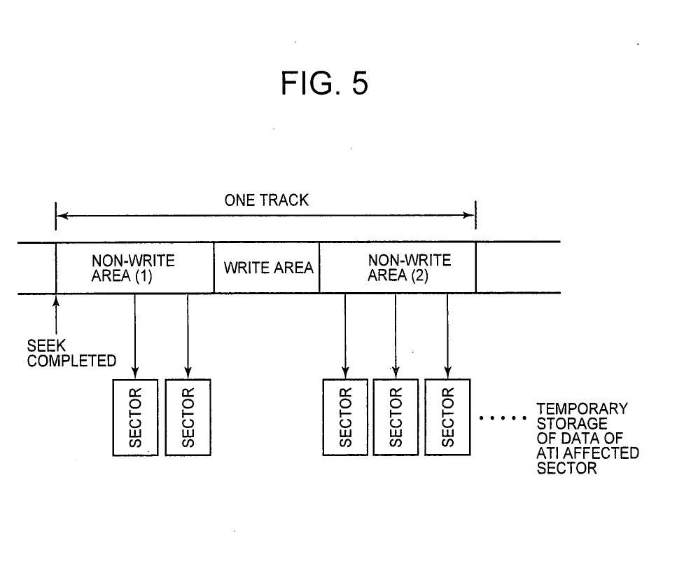

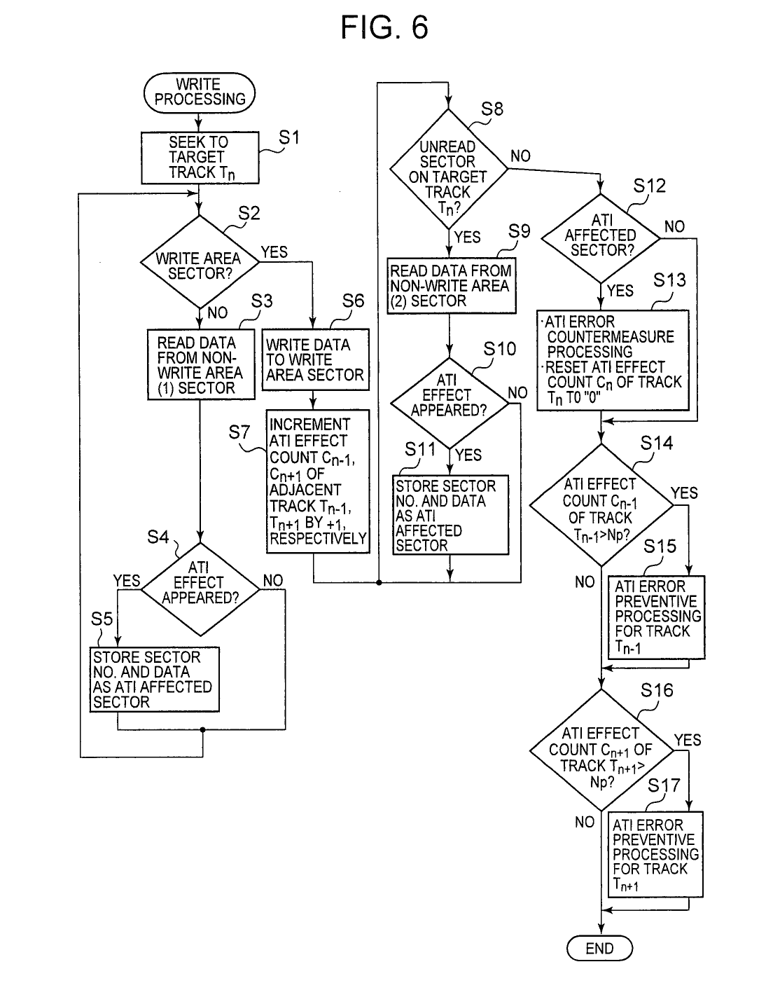

FIG. 5 depicts an apparatus for performing write processing, and FIG. 6 is a high-level logic flow diagram of a method for performing write processing. The following description assumes that the write target track is Tₙ.

As shown in FIG. 5, in the write processing, data are written to a write area (write target sector(s)), and the current effect of ATI on sectors in non-write areas (1) and (2) are checked. In FIG. 6, seeking to the target track Tₙ is first performed (step S1). After that, processing is performed in units of sectors in order from a sector that is at the top upon completion of seeking to the target track Tₙ. It is then determined whether the target sector is a write area sector or not (step S2). If the target sector is not the write area sector (No in step S2), data are read from a sector in the non-write area (1) (step S3) to determine whether the sector is affected by ATI (soft error) (step S4).

A determination is made whether or not the ECC correction capability P used in the above-mentioned medium soft-error stage is needed for the read data (i.e., the presence or absence of the ATI effect). Specifically, if an ECC correction capability equal to or higher than the ECC correction capability P is used for the read data in read/write signal processing section 17, it is determined that the ATI effect has appeared. If it is determined that the ATI effect (medium level of soft error) has not appeared (No in step S4), control returns to step S2 to perform processing on the next sector. If it is determined that the ATI effect (medium level of soft error) has appeared (Yes in step S4), the sector number and the read data are temporarily stored in RAM 23 as an ATI-affected sector (step S5). After that, control returns to step S2 to perform processing for the sector after the next.

On the other hand, if it is determined in step S2 that the target sector is the write area sector (Yes in step S2), data are written to the write area sector (step S6). Then, ATI effect counts Cₙ₋₁ and Cₙ₊₁ of the track Tₙ₋₁ and track Tₙ₊₁ adjacent to the target track Tₙ are incremented by +1, respectively (step S7). Processing is performed in units of tracks in such a manner that when data are written to the target track Tₙ, the ATI effect counts Cₙ₋₁ and Cₙ₊₁ of the adjacent track Tₙ₋₁ and track Tₙ₊₁ are incremented by +1, respectively, regardless of the number of sectors to which the data are written. In other words, the ATI effect counts Cₙ₋₁ and Cₙ₊₁ are incremented by +1 regardless of whether the data are written into one sector or multiple sectors on the target track Tₙ.

It is then determined whether there is any unread sector on the target track Tₙ (step S8). If there is any unread sector on the target track Tₙ (Yes in step S8), data are read from a corresponding sector in the non-write area (2) (step S9) to determine the presence or absence of the ATI effect (medium level of soft error) (step S10). The method of determining the ATI effect is the same as that in the step S4.

If it is determined that the ATI effect (medium level of soft error) has not appeared (No in step S10), control returns to step S8 to perform the same processing on the next sector. If it is determined that the ATI effect (medium level of soft error) has appeared (Yes in step S10), the sector number and the read data are temporarily stored in RAM 23 as an ATI-affected sector (step S11), and control returns to step S8 to perform the same processing on the sector after the next.

On the other hand, if there is no unread sector on the target track Tₙ (No in step S8), a determination is made whether or not there is any ATI affected sector stored in RAM 23 in steps S5 and S11 (step S12). If there is no ATI affected sector (No in step S12), control goes to step S14. If there is any ATI affected sector (Yes in step S12), the ATI error counter-measure processing is performed, and the ATI effect count Cₙ of the track Tₙ is reset to “0” (step S13). After that, control goes to step S14. In the ATI error countermeasure processing, rerecording of data (data after subjected to ECC error correction), sector replacement (recording of data in a different sector), etc. are performed to prevent the occurrence of ATI errors.

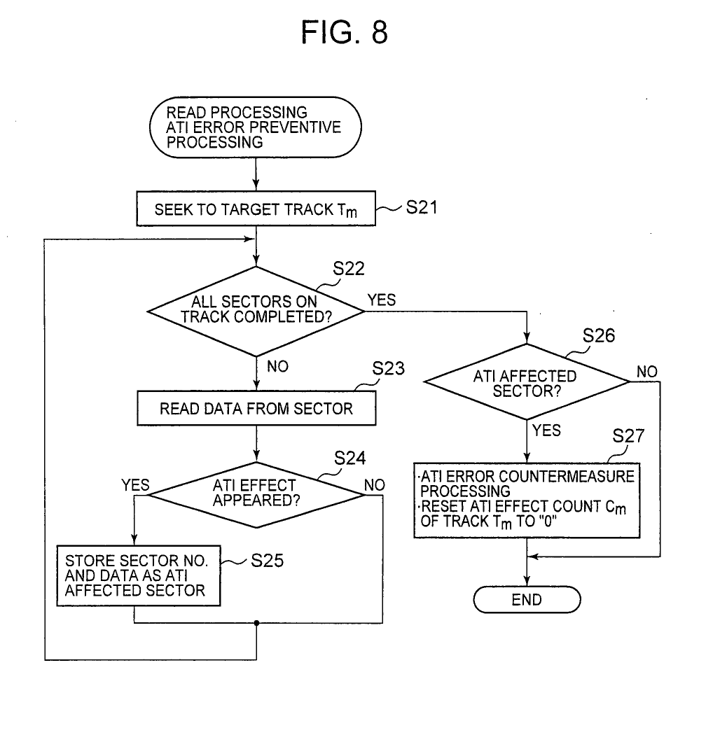

In step S14, a determination is made whether or not the ATI effect count Cₙ₋₁ of the track Tₙ−1 is greater than the permissible ATI count Np. If the ATI effect count Cₙ₋₁ of the track Tₙ₋₁ is not greater than the permissible ATI count Np (No in step S14), control goes to step S16. If the ATI effect count Cₙ₋₁ of the track Tₙ₋₁ is greater than the permissible ATI count Np (Yes in step S14), the ATI error preventive processing (see FIG. 8) is performed for the track Tₙ₋₁ (step S15). After that, control goes to step S16.

In step S16, a determination is made whether or not the ATI effect count Cₙ₊₁ of the track Tₙ₊₁ is greater than the permissible ATI count Np. If the ATI effect count Cₙ₊₁ of the track Tₙ₊₁ is not greater than the permissible ATI count Np (No in step S16), this flow ends, while if the ATI effect count Cₙ₊₁ of the track Tₙ₊₁ is greater than the permissible ATI count Np (Yes in step S16), the ATI error preventive processing (see FIG. 8) is performed for the track Tₙ₊₁ (step S17), and the process ends.

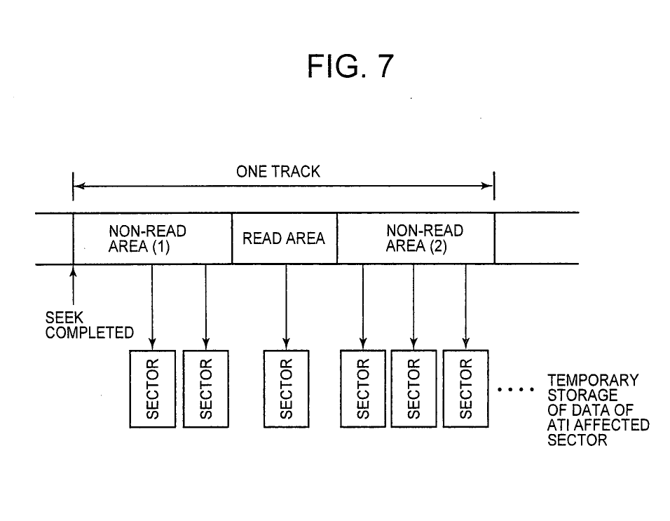

FIG. 7 depicts an apparatus for performing the read processing, and FIG. 8 is a high-level logic flow diagram of a method for performing read processing and ATI error preventive processing. The following description assumes that the target track for reading or ATI error preventive processing is Tₘ (where m=1 to N).

As shown in FIG. 7, in the read processing, the current effect of ATI on sectors in non-read target areas (1) and (2), and a sector corresponding to a read area are checked. The read area is an area (sector(s)) in which data are held at the time of receiving a request from the outside to read the data. The difference between the read processing and the ATI error preventive processing is whether there is a read target area or not. In the ATI error preventive processing, all sectors are non-read target areas. In FIG. 8, the read processing and the ATI error preventive processing are illustrated together without particularly distinguishing between the read area and the non-read target areas.

In FIG. 8, seeking to the target track Tₘ is first performed (step S21). After that, processing is performed in units of sectors in order from a sector that is at the top upon completion of seeking to the target track Tₘ. It is then determined whether checking is completed for all the sectors on the target track Tₘ (step S22). If it is not completed for all the sectors on the target track Tₘ (No in step S22), data are read from an unchecked sector (step S23) to determine the ATI effect (medium level of soft error) has appeared on the sector or not (step S24).

If it is determined that the ATI effect (medium level of soft error) has not appeared (No in step S24), control returns to step S22 to perform the same processing for the next sector. If it is determined that the ATI effect (medium level of soft error) has appeared (Yes in step S24), the sector number and the read data are temporarily stored in the RAM 23 as an ATI-affected sector (step S25), and control returns to step S22 to perform the same processing for the sector after the next.

On the other hand, if it is determined in step S22 that checking is completed for all the sectors on the track Tₘ (Yes in step S22), it is then determined whether there is any ATI affected sector stored in the RAM 23 in step S25 (step S26). If there is no ATI affected sector (No in step S26), this flow ends, while if there is any ATI affected sector (Yes in step S26), the ATI error countermeasure processing is performed, and an ATI effect count Cm of the track Tₘ is reset to “0” (step S27). After that, this flow ends.

As described above, according to the embodiment 1, when data are written to the target track Tₙ, the ATI effect counts Cₙ₋₁ and Cₙ₊₁, are counted for the track Tₙ₋₁ and the track Tₙ₊₁ adjacent to the track Tₙ, respectively. It is then determined whether the ATI effect counts Cₙ₋₁, Cₙ₊₁ are greater than the permissible ATI count Np. If either of the ATI effect counts Cₙ₋₁, Cₙ₊₁ is greater than the permissible ATI count Np, the ATI error preventive processing is performed for the corresponding one of the track Tₙ₋₁ and the track Tₙ₊₁ to determine the presence or absence of the ATI effect on data of all the sectors on the corresponding one of the track Tₙ₋₁ and the track Tₙ₊₁. Then, if there is a sector affected by ATI, the ATI error countermeasure processing (data rerecording or sector replacement) is performed on the ATI affected sector to recover data in the ATI affected sector. Since the data of the ATI affected sector are recovered in the medium soft-error stage, read error(s) (severe level of soft error and hard error) on adjacent tracks can be prevented from occurring due to the ATI effect. This makes it possible to determine the ATI effect accurately in order to prevent the occurrence of read error(s) on adjacent tracks due to the ATI effect with a high degree of accuracy.

Further, after the ATI error countermeasure processing (data rerecording or sector replacement) is performed, the ATI effect counts Cₙ₋₁ and Cₙ₊₁ of the track Tₙ₋₁ and the track Tₙ₊₁ are reset to “0”. Therefore, ATI effects on the track Tₙ₋₁ and the track Tₙ₊₁ caused by writing to the track Tₙ after data recovery can be prevented with a high degree of accuracy.

Further, according to the embodiment 1, when data are written to the target track Tₙ, the presence or absence of the ATI effect on data of sectors in the non-write areas of the track Tₙ is determined, and the ATI error countermeasure processing (data rerecording or sector replacement) is performed on the sector(s) determined to be affected by ATI to recover the data in the sector(s). This makes it possible to prevent read errors from sectors in the non-write areas of the write target track Tₙ from occurring due to the effect of ATI with a high degree of precision.

Furthermore, according to the embodiment 1, when data are read from the read target track Tₘ, it is determined whether or not anything is wrong with data of the sectors on the track Tₘ, and the ATI error countermeasure processing (data rerecording or sector replacement) is performed on the ATI affected sector(s) to recover the data of the sector(s). This makes it possible to prevent read error(s) from the sectors on the read target track Tₘ from occurring due to the ATI effect with a high degree of precision.

Since the time required to actual reading from and writing to the disk 11 is longer than the time required for the firmware determination routine, there is no performance degradation during normal operation. For example, suppose that the value of the permissible ATI count Np is 100,000 times. Suppose further that data are written to a portion sequentially at a rate of one per second. Even in such a case, it takes about 27 hours to reach the permissible ATI count Np. Therefore, the frequency to perform the ATI error preventive processing is less than once a day even if the hard disk drive is continuously operated, and this does not affect the processing speed.

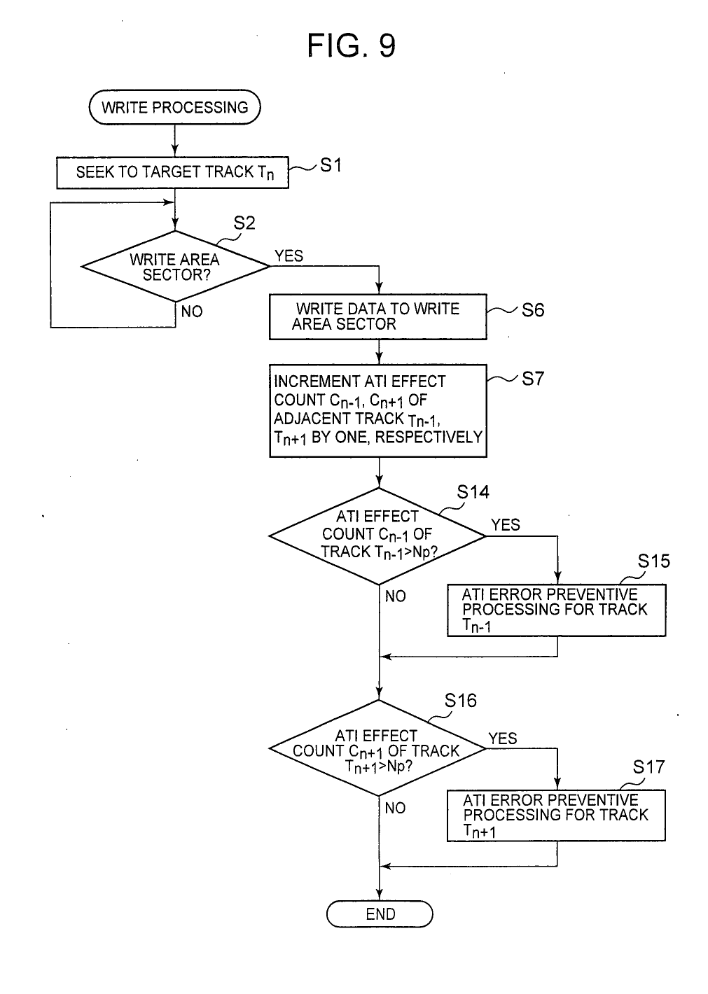

FIG. 9 is a high-level logic flow diagram of a method for performing write processing according to an embodiment 2 of the present invention. In FIG. 9, steps in which operations equivalent to those in FIG. 6 are performed are given the same step numbers. The write processing according to the embodiment 1 (FIGS. 5 and 6) is to check the ATI effect on the non-write areas. On the other hand, in the write processing according to the embodiment 2, the ATI effect on the non-write areas are not checked. Since the steps in the write processing shown in FIG. 9 are substantially the same as those in FIG. 6 except that steps S3 to A5 and S8 to S13 in FIG. 6 are deleted, the detailed description thereof will be omitted.

Further, the ATI effect is also checked in the read processing according to the embodiment 1, but the embodiment 2 can be configured not to check the ATI effect in the read processing.

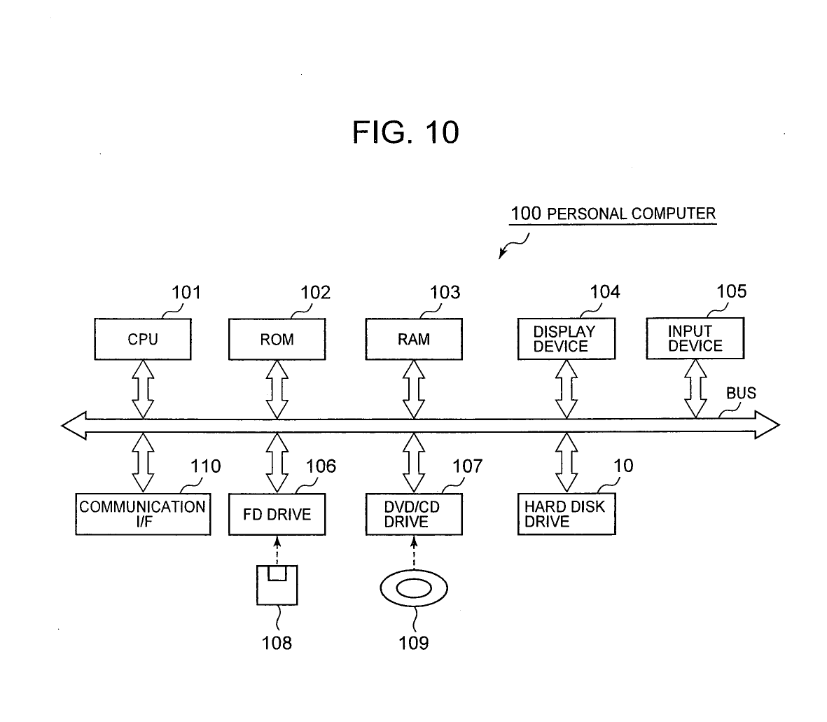

Hard disk drive 10 of the embodiment 1 and the embodiment 2 can be widely applied to a personal computer (PS), AV equipment (e.g., video recorders), etc. FIG. 10 is a block diagram illustrating hard disk drive 10 of the embodiment 1 and the embodiment 2 being applied to a personal computer. As shown in FIG. 10, a personal computer 100 includes a central processing unit 101, a read-only memory 102, a random access memory 103, a display device 104, an input device 105, an FD drive 106 for performing reading/writing of data with respect to an FD 108, a DVD/CD drive 107 for reading of data from a DVD/CD 109, a communication interface 110, and hard disk drive 10.

As has been described, the present invention provides an improved method and apparatus for recording data on a magnetic recording medium.

Although the aforementioned embodiments describe the hard disk drive, the magnetic recording system according to the present invention is not limited to the hard disk drive, and it can be applied to any other magnetic recording system for recording data in units of tracks on magnetic recording media, such as for a flexible disk, a Compact Disk Recordable (CD-R), and a Digital Versatile Disk Recordable (DVD-R), or a magneto optical disk drive for magneto optical disks.

While the invention has been particularly shown and described with reference to a preferred embodiment, it will be understood by those skilled in the art that various changes in form and detail may be made therein without departing from the spirit and scope of the invention.

What is claimed is:

1. A method for recording data on a magnetic recording medium, said method comprising:
providing an adjacent track interference (ATI) compensation table for storing an ATI effect count Cₙ along with an associated track Tₙ;
counting a number of ATI effects for said track Tₙ;
recording said ATI effects count in said ATI compensation table;
determining whether or not there is any ATI affected sector appeared in said ATI compensation table; and
in a determination that there is an ATI affected sector appeared in said ATI compensation table, preforming ATI error countermeasure processing to recover data and resetting said ATI effect count Cₙ for said track Tₙ.

2. The method of claim 1, wherein said counting and recording further includes
reading data from a first non-write area sector immediately adjacent to a write area sector within said track Tₙ;
determining whether or not ATI effect appears on said read data from said first non-write area sector; and
in a determination that ATI effect appears on said read data from said first non-write area sector, storing said read data and a sector number of said first non-write area sector as an ATI affected sector.

3. The method of claim 3, wherein said method further includes
reading data from a second non-write area sector immediately adjacent to said write area sector within said track Tₙ;
determining whether or not ATI effect appears on said read data from said second non-write area sector; and
in a determination that ATI effect appears on said read data from said second non-write area sector, storing said read data and a sector number of said second non-write area sector as an ATI-affected sector.

4. The method of claim 1, wherein said method further includes
providing an ATI effect count Cₙ₋₁ and an ATI effect count Cₙ₊₁;
incrementing said ATI effect counts Cₙ₋₁ and Cₙ₊₁ after writing data to said track Tₙ, wherein said track Tₙ is immediately adjacent to tracks Tₙ₋₁ and Tₙ₊₁, wherein said tracks Tₙ₋₁ and Tₙ₊₁ are associated with said ATI effect counts Cₙ₋₁ and Cₙ₊₁, respectively;
determining whether or not said ATI effect count Cₙ₊₁ is greater than a predetermined permissible ATI count;
in a determination that said ATI effect count Cₙ₊₁ is greater than said predetermined permissible ATI count, preforming ATI error preventive processing to recover data on said track Tₙ₊₁;
determining whether or not said ATI effect count Cₙ₊₁ is greater than said predetermined permissible ATI count; and
in a determination that said ATI effect count Cₙ₊₁ is greater than said predetermined permissible ATI count, preforming ATI error preventive processing to recover data on said track Tₙ₊₁.

5. A computer storage medium having a computer program product for recording data on a magnetic recording medium, said computer storage medium comprising:
computer program code for providing an adjacent track interference (ATI) compensation table for storing an ATI effect count Cₙ along with an associated track Tₙ;
computer program code for counting a number of ATI effects for said track Tₙ;
computer program code for recording said ATI effects count in said ATI compensation table;
computer program code for determining whether or not there is any ATI affected sector appeared in said ATI compensation table; and
computer program code for, in a determination that there is an ATI affected sector appeared in said ATI compensation table, preforming ATI error countermeasure processing to recover data and resetting said ATI effect count Cₙ for said track Tₙ.

6. The computer storage medium of claim 5, wherein said computer program code for counting and recording further includes
computer program code for reading data from a first non-write area sector immediately adjacent to a write area sector within said track Tₙ;
computer program code for determining whether or not ATI effect appears on said read data from said first non-write area sector; and
computer program code for, in a determination that ATI effect appears on said read data from said first non-write area sector, storing said read data and a sector number of said first non-write area sector as an ATI affected sector.

7. The computer storage medium of claim 6, wherein said computer storage medium further includes
computer program code for reading data from a second non-write area sector immediately adjacent to said write area sector within said track Tₙ;
computer program code for determining whether or not ATI effect appears on said read data from said second non-write area sector; and
computer program code for, in a determination that ATI effect appears on said read data from said second non-write area sector, storing said read data and a sector number of said second non-write area sector as an ATI-affected sector.

8. The computer storage medium of claim 5, wherein said computer storage medium further includes computer program code for providing an ATI effect count Cₙ₋₁ and an ATI effect count Cₙ₊₁;
computer program code for incrementing said ATI effect counts Cₙ₋₁ and Cₙ₊₁ after writing data to said track Tₙ, wherein said track Tₙ is immediately adjacent to tracks Tₙ₋₁ and Tₙ₊₁, wherein said tracks Tₙ₋₁ and Tₙ₊₁ are associated with said ATI effect counts Cₙ₋₁ and Cₙ₊₁, respectively;
computer program code for determining whether or not said ATI effect count Cₙ₋₁ is greater than a predetermined permissible ATI count;
computer program code for, in a determination that said ATI effect count Cₙ₋₁, is greater than said predetermined permissible ATI count, preforming ATI error preventive processing to recover data on said track Tₙ₋₁;
computer program code for determining whether or not said ATI effect count Cₙ₊₁ is greater than said predetermined permissible ATI count; and
computer program code for, in a determination that said ATI effect count Cₙ₊₁ is greater than said predetermined permissible ATI count, preforming ATI error preventive processing to recover data on said track Tₙ₊₁.

9. An apparatus for recording data on a magnetic recording medium, said apparatus comprising:
a detector for detecting an ATI effects count Cₙ for a track Tₙ;
an adjacent track interference (ATI) compensation table for storing said ATI effect count Cₙ along with said track Tₙ; and
a processor for determining whether or not there is any ATI affected sector appeared in said ATI compensation table, and for preforming ATI error countermeasure processing to recover data and resetting said ATI effect count Cₙ for said track Tₙ in a determination that there is an ATI affected sector appeared in said ATI compensation table.

10. The apparatus of claim 9, wherein said detector further includes a reader for reading data from a first non-write area sector immediately adjacent to a write area sector within said track Tₙ,
such that said processor determines whether or not ATI effect appears on said read data from said first non-write area sector and stores said read data and a sector number of said first non-write area sector as an ATI affected sector, in a determination that ATI effect appears on said read data from said first non-write area sector.

11. The apparatus of claim 10, wherein said apparatus further includes
a reader for reading data from a second non-write area sector immediately adjacent to said write area sector within said track Tₙ,
such that said processor determines whether or not ATI effect appears on said read data from said second non-write area sector, and storing said read data and a sector number of said second non-write area sector as an ATI-affected sector, in a determination that ATI effect appears on said read data from said second non-write area sector.

12. The apparatus of claim 9, wherein said apparatus further includes
a counter for incrementing ATI effect counts Cₙ₋₁ and Cₙ₊₁ after writing data to said track Tₙ, wherein said track Tₙ is immediately adjacent to tracks Tₙ₋₁ and Tₙ₊₁, wherein said tracks Tₙ₋₁ and Tₙ₊₁ are associated with said ATI effect counts Cₙ₋₁ and Cₙ₊₁, respectively; and
said processor determines whether or not said ATI effect count Cₙ₋₁is greater than a predetermined permissible ATI count, and determines whether or not said ATI effect count Cₙ₊₁ is greater than said predetermined permissible ATI count, and preforms ATI error preventive processing to recover data on said track Tₙ₋₁ when said ATI effect count Cₙ₋₁ is greater than said predetermined permissible ATI count, and preforms ATI error preventive processing to recover data on said track Tₙ₊₁ when said ATI effect count Cₙ₊₁ is greater than said predetermined permissible ATI count.
